(19) United States
(12) Patent Application Publication
(10) Pub. No.: US 2015/0146746 A1
(43) Pub. Date: May 28, 2015

(54) Method of Providing Mobility Support to Internet Protocol Version 6 (IPv6) using Filtering Technology

(71) Applicant: Macau University of Science and Technology, Taipa (MO)

(72) Inventor: Chak Fong CHEANG, Taipa (MO)

(73) Assignee: Macau University of Science and Technology, Taipa (MO)

(21) Appl. No.: 14/201,947

(22) Filed: Mar. 10, 2014

(30) Foreign Application Priority Data
Nov. 26, 2013 (AU) 2013101550

(51) Int. Cl. H04W 8/26

(52) U.S. Cl. CPC H04W 8/26; H04W 80/045
USPC 370/467

(57) ABSTRACT

A method of providing mobility support to Internet Protocol version 6 (IPv6) using filtering technology is disclosed. The method comprises the steps of: providing a filter layer below the internet layer and above the network access layer in the TCP/IP stack; and modifying the packets using the filter layer. The step of modifying packets further comprises the steps of detecting the movement of a mobile node, and updating the movement of the mobile node to other nodes. The step of detecting the movement of the mobile node further comprises a step of replacing the prefix in the receiving packets before passing the receiving packets to the non-mobility-capable IPv6 module of the internet layer for hiding the movement of the mobile node; The step of modifying the packets also comprises the steps of adding extension headers to the packets, deleting extension headers from the packets and replacing IP addresses of the packets for the survivability of the ongoing connections.

### CROSS-REFERENCE TO RELATED APPLICATION

The present application claims priority under 35 U.S.C. §119 to Australian Innovation Patent Application No. 2013-101550 filed on Nov. 26, 2013. The content of the application is incorporated herein by reference in its entirety.

### FIELD OF INVENTION

This invention relates to a method of providing mobility support to Internet Protocol version 6 (IPv6), and in particular a method of providing mobility support to IPv6 using filtering technology.

### BACKGROUND OF INVENTION

Internet Protocol version 6 (IPv6) was not originally designed for mobility communication. When an IPv6 node (simply referring to “a node”) changes its point of attachment in an IPv6 network, its IPv6 address might change and thus the existing connections, which use the previously assigned IPv6 address, are terminated.

To deal with the aforesaid problem, Mobile Internet Protocol version 6 (MIPv6) is proposed. MIPv6 introduces the necessary mechanisms required for providing mobility support to IPv6, and thus allows a node to be mobile in an IPv6 network and can maintain the existing connections uninterrupted.

Two main mechanisms are introduced to IPv6 in order to achieve the aforementioned capability of mobility. The first mechanism is delivery reachability which guarantees a node is always reachable regardless of the change of its location. The second mechanism is transport layer transparency which guarantees a node's existing transport layer connections are survivable regardless of the change of its address.

As shown in FIG. 1a, conventionally, these mechanisms are introduced by combining MIPv6 to IPv6 directly into a single protocol, which requires modifying the original source codes of IPv6. This approach is considered as a difficult task because the IPv6 module of the TCP/IP stack installed in most operating system platforms is not always open to the public. Moreover, such combination involves massive modification of the algorithms and the data structures in the original source codes of the IPv6 module.

### SUMMARY OF INVENTION

In the light of the foregoing background, the objective of the present invention is to propose an alternate method of providing mobility support to IPv6, without the need to understand and modify the existing source codes of IPv6. In particular, it is related to a method of providing the MIPv6-compatible mobility support to IPv6 using filtering technology.

Accordingly, the present invention, in one aspect, is a method of combining the MIPv6 mechanisms to the existing non-mobility-capable IPv6 module of the TCP/IP stack so as to provide mobility support to IPv6. The method comprises the steps of (1) providing a filter layer between the internet layer and the network access layer in the TCP/IP stack, wherein the filter layer is below the internet layer and above the network access layer; and (2) modifying the IPv6 packets (simply referring to “packets”) by using the filter layer, wherein the filter layer modifies both the formats and the contents of the sending and the receiving packets. In one embodiment, the internet layer is encoded with a non-mobility-capable IPv6 module and the filter layer is encoded with a filtering protocol module supporting the MIPv6 mechanisms.

In one embodiment of the present invention, the step of modifying the packets using the filter layer further comprises the steps of detecting the movement of a mobile node by the filter layer, and updating said movement of the mobile node to the home agent and the correspondent nodes by the filter layer.

In one embodiment, the step of detecting the movement of the mobile node further comprises a step of hiding the movement of the mobile node from the non-mobility-capable IPv6 module of the internet layer by replacing the prefix in the receiving packets before passing the receiving packets to the upper internet layer.

In one embodiment, the step of updating the movement of the mobile node to the home agent and the correspondent nodes further comprises the steps of (1) sending a binding update from the filter layer of the mobile node to the home agent and the correspondent nodes, wherein the binding update comprises a first address at home subnet of the mobile node and a second address at current foreign subnet of the mobile node; and (2) replying a binding acknowledgement from the filter layer of one of the correspondent nodes to the mobile node, when the correspondent node receives a binding update from the mobile node.

In another embodiment of the present invention, when the mobile node is communicating with a mobility-capable correspondent node, the step of modifying the packets further comprises the steps of adding the extension headers and replacing the IP addresses to the sending packets; and deleting the extension headers and restoring the IP addresses from the receiving packets.

In another embodiment of the present invention, when the mobile node is communicating with a non-mobility-capable correspondent node, the step of modifying the packets further comprises the steps of tunneling the sending packets to the correspondent node via the home agent; and restoring the receiving tunneled packets by the filter layer.

The advantages of the present invention is that it provides an efficient and flexible method of providing MIPv6-compatible mobility support based on the existing non-mobility-capable IPv6 module and eliminates the difficulty of programming in modifying the original source codes of the IPv6 module in the TCP/IP stack.

### BRIEF DESCRIPTION OF FIGURES

FIG. 1a illustrates the scheme of protocol design according to the conventional method.

FIG. 1b illustrates the scheme of protocol design according to an embodiment of the present invention.

FIG. 2a illustrates the step of detecting movement in the filter layer when the node is at home link according to an embodiment of the present invention; and FIG. 2b illustrates the step of detecting movement in the filter layer when the node is at foreign link according to the same embodiment of the present invention.

FIG. 3a and FIG. 3b illustrate the steps of updating movement in the filter layer according to an embodiment of the present invention. In particular, FIG. 3a illustrates the sending of binding update; and FIG. 3b illustrates the replying of binding acknowledgement.

FIG. 4a illustrates the step of modifying a sending packet using extension headers in the filter layer according to an embodiment of the present invention; and FIG. 4b illustrates the step of modifying a receiving packet using extension headers in the filter layer according to the same embodiment of the present invention.

FIG. 5a illustrates the step of tunneling a sending packet in the filter layer according to an embodiment of the present invention; and FIG. 5b illustrates the step of restoring a receiving tunneled packet in the filter layer according to the same embodiment of the present invention.

### DETAILED DESCRIPTION OF THE PREFERRED EMBODIMENTS

As used herein and in the claims, “comprising” means including the following elements but not excluding others.

As used herein and in the claims, a ‘layer’ means a generic network layer in the protocol stack, which can include one or more protocol modules that are implemented by software. One protocol module in a layer can exchange information with another protocol module in the upper layer or in the lower layer.

As used herein and in the claims, “mobile node (MN)” refers to an IPv6 node capable of moving from a home link to a foreign link and vice versa; and “correspondent node (CN)” refers to the node which communicates with the mobile node. A node which movement is detected is a mobile node, and becomes a correspondent node when the node is communicating with another mobile node.

In the figures, the names of the protocol modules installed in each layer of the TCP/IP stack are shown in the brackets. Moreover, the arrows denote the flow of packets from a source to a destination. The down arrows denote the flow of sending packets from the upper layers to the lower layers and the up arrows denote the flow of receiving packets from the lower layers to the upper layers.

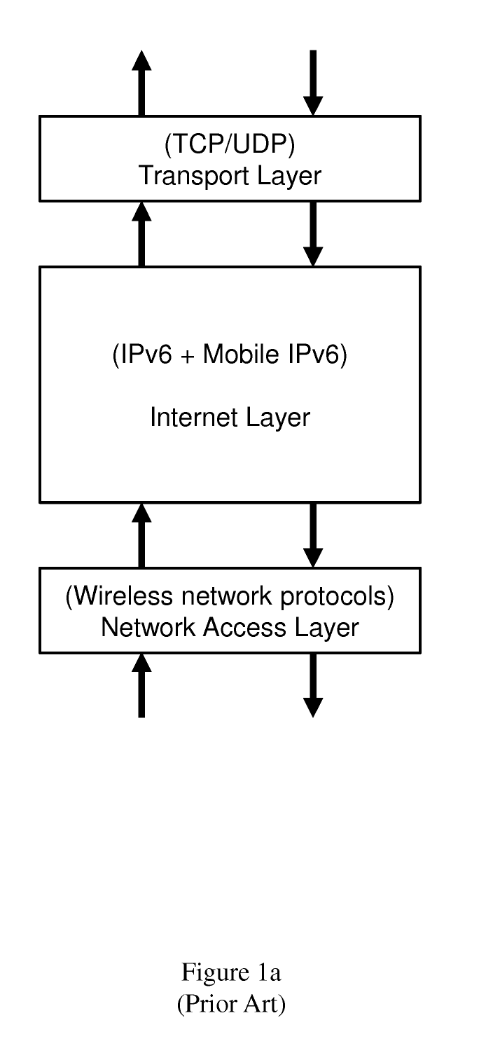

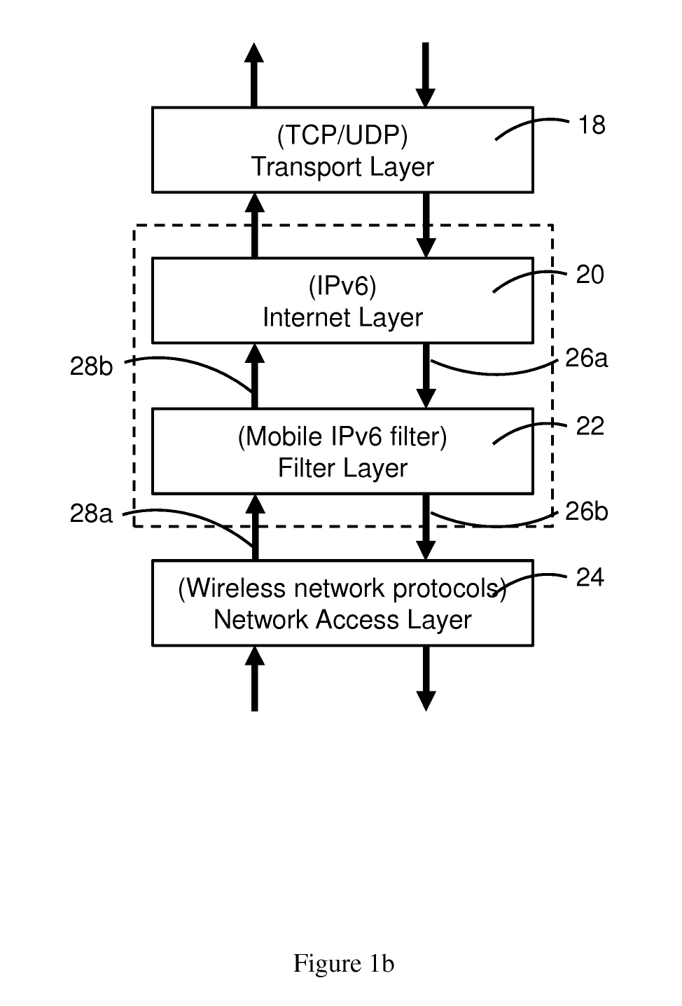

As shown in FIG. 1b, in one aspect, the present invention is a method of providing MIPv6-compatible mobility support to IPv6 using filtering technology. The method comprises a step of providing a filter layer 22, inserted between the internet layer 20 and the network access layer 24 in the TCP/IP stack. The internet layer 20 is encoded with a non-mobility-capable IPv6 module and the filter layer 22 is encoded with the filtering protocol module supporting the MIPv6 mechanisms. Thus the combination of the internet layer 20 and the filter layer 22 allows the non-mobility-capable IPv6 module behaves as a mobility-capable protocol.

In one embodiment, the method comprises a step of filtering the packets by modifying both the formats and the contents of the sending and the receiving packets using the filter layer 22. The filter layer 22 is designed to modify the sending packets (packets that received from the upper internet layer 20 in a format of IPv6 standard) along the down arrow path 26a and pass the modified sending packets along the path 26b to the lower network access layer 24 in a format that is acceptable by the MIPv6 standard. The filter layer 22 is also designed to modify the receiving packets (packets that received from lower the network access layer 24) along the up arrow path 28a and pass the modified receiving packets along the path 28b to the upper internet layer 20 in a format that is acceptable by the IPv6 standard.

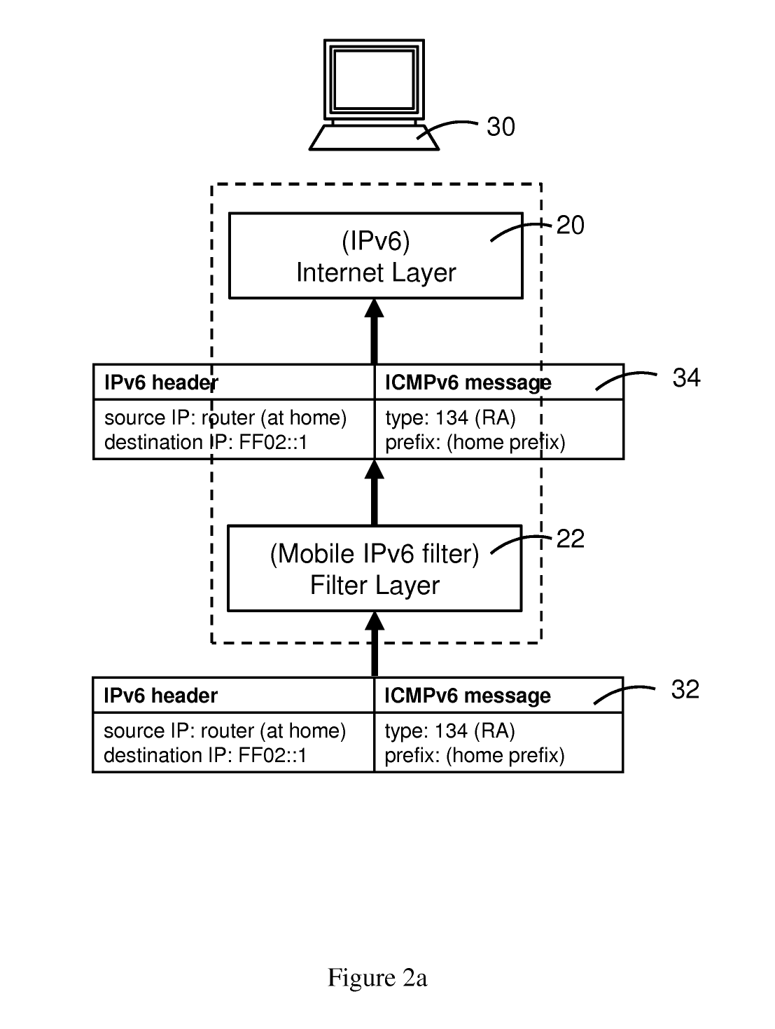

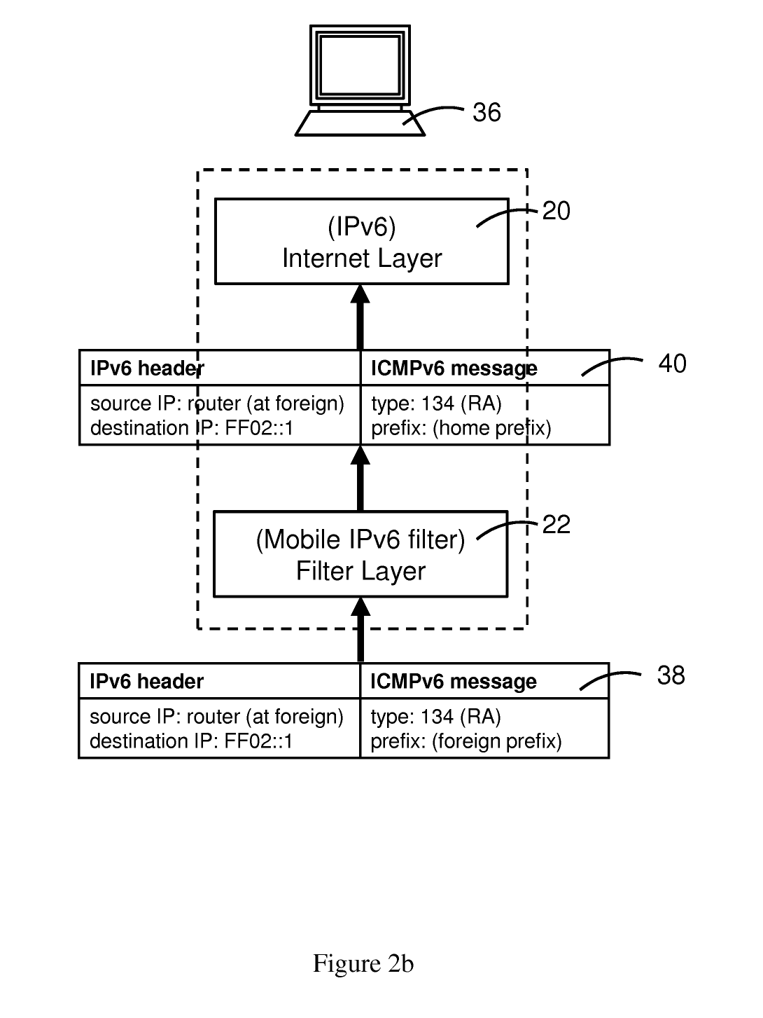

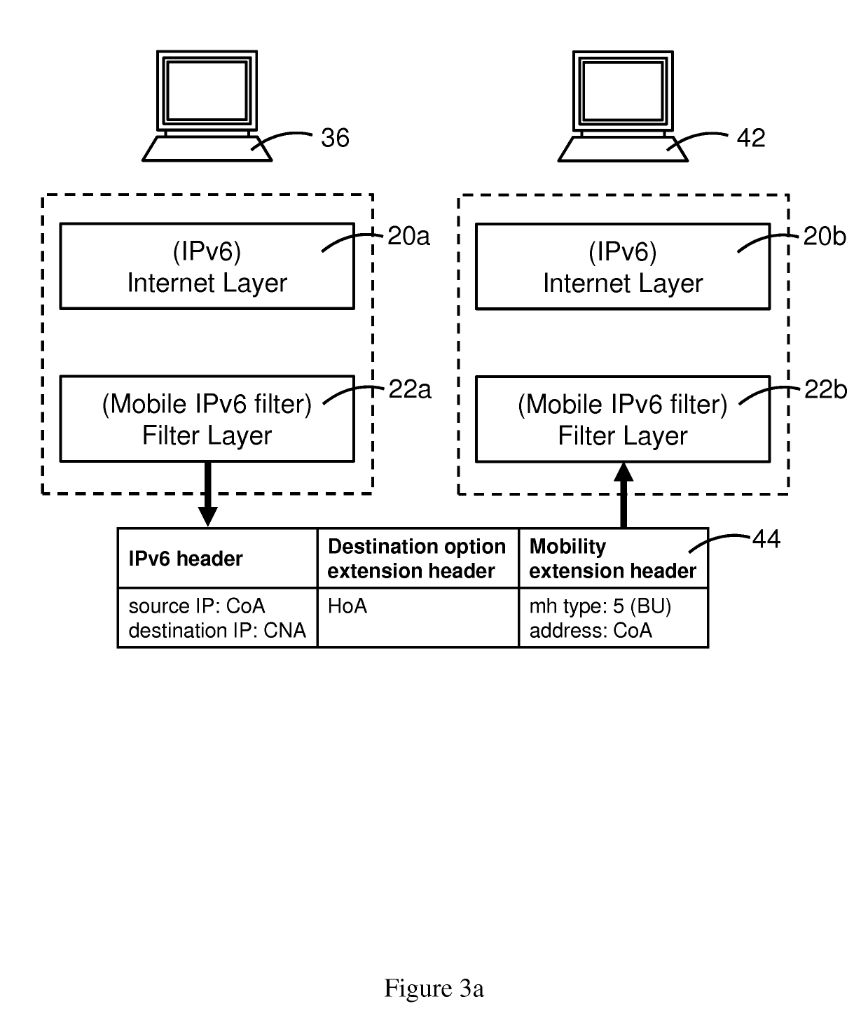

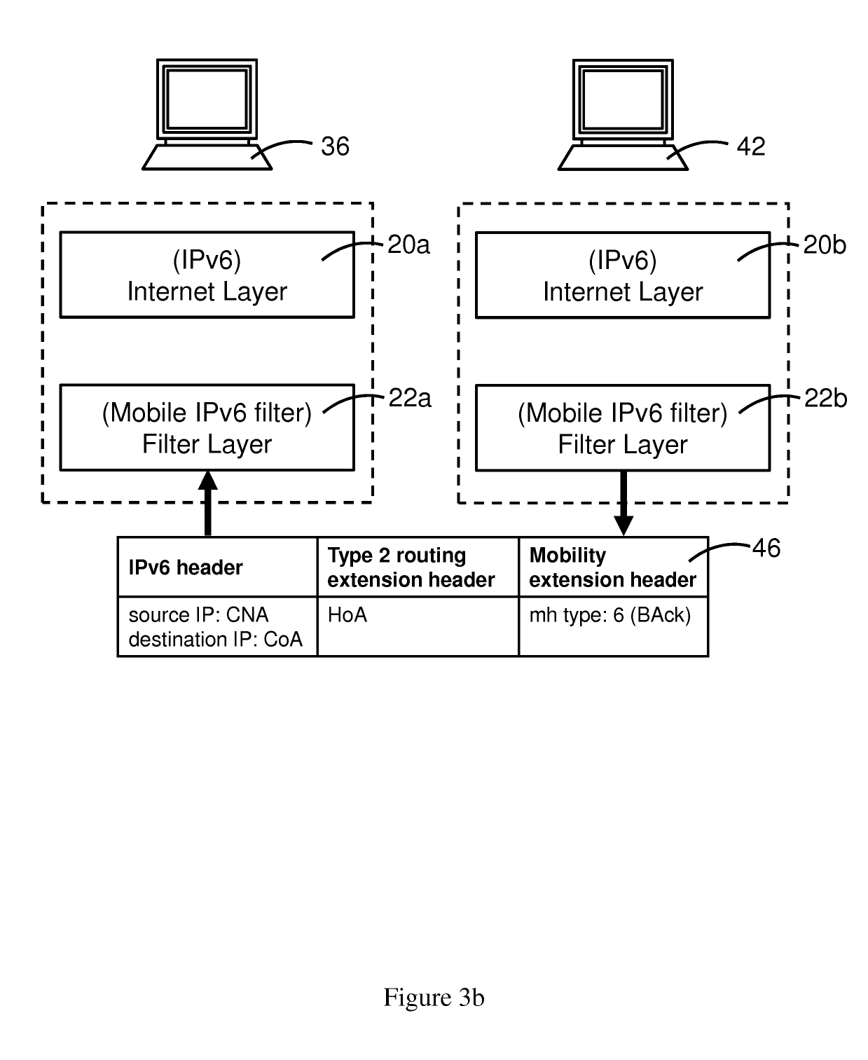

In one embodiment, the step of modifying the packets using the filter layer 22 enables data communication between a mobile node and a correspondent node even when the mobile node is away from its home network. The step of modifying the packets further comprises the steps of detecting the movement of a mobile node; and updating the movement of the mobile node to the home agent and all correspondent nodes. The step of detecting the movement of the mobile node further comprises a step of hiding the movement of the mobile node from the non-mobility-capable IPv6 module of the internet layer 20. In a further embodiment, the step of hiding the movement of the mobile node further comprises a step of replacing the prefix in the receiving packets before passing the receiving packets to the internet layer 20. The details of the aforesaid steps are illustrated and explained in FIG. 2 and FIG. 3.

Referring to FIG. 2a, when a node 30 is at home link, the node 30 receives an Internet Control Message Protocol version 6 (ICMPv6) router advertisement (RA) message 32 that generated by the router in the home subnet at regular interval to advertise the prefix of home subnet and configuration options to all nodes under this home subnet. The packet of RA message 32 comprises an IPv6 header and an ICMPv6 message. The ICMPv6 message defines the type as ‘134’ and the prefix as “home prefix”. In an embodiment, the RA message 32 is then passed to the filter layer 22 of the node 30. The filter layer 22 records the home prefix and forms an IPv6 address (referring as “home address (HoA)”). In a further embodiment, if the home agent (H) flag is set in the RA message 32, it indicates that the router is capable of being a home agent (HA) and the filter layer 22 records the router's address (referring as “home agents address (HAA)”) in the home agents list (HAL). As the node is at home subnet, the filter layer 22 then passes the un-modified RA message 34 to the upper internet layer 20.

Referring to FIG. 2b, when the node (now referring as “mobile node 36”) moves from home link to foreign link or from one foreign link to another foreign link, the mobile node 36 also receives another RA message 38 that generated by the router in the foreign subnet at regular interval to advertise the prefix of the current foreign subnet and configuration options to all nodes under this foreign subnet. The packet of RA message 38 comprises an IPv6 header and an ICMPv6 message. The ICMPv6 message defines the type as ‘134’ whereas the prefix as “foreign prefix”. In an embodiment, the RA message 38 is then passed to the filter layer 22 of the mobile node. The filter layer 22 compares the prefix in the RA message 38 with the “home prefix” and records the prefix as “foreign prefix” if two prefix are not identical, and then forms a second IPv6 address (referring as “care-of address (CoA)”). In a further embodiment, the filter layer 22 replaces the foreign prefix with the home prefix and forms a modified RA message 40. The modified RA message 40 is then passed to the upper internet layer 20, hiding the movement of the mobile node 36 to the non-mobility-capable IPv6 module. In a specific embodiment, for successfully discovering the neighbors in the foreign subnet, the prefix in all upcoming receiving ICMPv6 neighbor solicitation (NS) messages needs to be changed by the filter layer 22 of the mobile node 36 from “foreign prefix” to “home prefix” before passing it to the upper internet layer 20, and the prefix in all replying neighbor advertisement (NA) messages also needs to be restored from “home prefix” back to “foreign prefix” before passing it to the lower network access layer. In another embodiment, if the CoA is different from the HoA in the filter layer, the movement of the mobile node 36 is determined, and thus triggers the step of updating movement.

Referring to FIG. 3a, in case a movement is determined, the filter layer 22a of the mobile node 36 performs a step of updating the movement to all other nodes communicating with the mobile node respectively. In an embodiment, the step of updating the movement further comprises a step of sending a packet (referring as “binding update (BU) 44”) to the home agent and all correspondent nodes 42. In a specific embodiment, the binding update 44 is generated by the filter layer 22a of the mobile node 36. The packet of binding update 44 comprises an IPv6 header, a destination option extension header and a mobility extension header. The IPv6 header defines the source IP and the designation IP. In one specific embodiment, the source IP is the CoA and the destination IP is the address of correspondent node, CNA. The destination option extension header comprises the HoA. The mobility extension header defines the type as “5 (BU)” and comprises an address of CoA. In another embodiment, when the filter layer 22b of a correspondent node 42 receives the binding update 44, the filter layer 22b records the binding of the mobile node 36 in the binding cache (BC), and then deletes the binding update 44 without passing it to the upper internet layer 20b. Thus the steps of sending and receiving binding update 44 do not involve the internet layer 20a of the mobile node 36 or the internet layer 20b of the correspondent node 42. In one embodiment, the BC is maintained by the correspondent node 42 only.

Referring to FIG. 3b, in an embodiment, in case a specific correspondent node 42 receives the binding update 44 from the mobile node 36, the filter layer 22b of the correspondent node 42 performs a step of replying a packet (referring as “binding acknowledgement (BAck) 46”) to the mobile node 36. In a specific embodiment, the binding acknowledgement 46 is generated by the filter layer 22b of correspondent node 42. The packet of binding acknowledgement 46 comprises an IPv6 header, a type 2 routing extension header and a mobility extension header. The IPv6 header defines the source IP and the designation IP. In one specific embodiment, the source IP is the CNA and the destination IP is the CoA. The type 2 routing extension header comprises the HoA. The mobility extension header defines the type as “6 (BAck)”. In another embodiment, when the filter layer 22a of the mobile node 36 receives the binding acknowledgement 46 before the timer (predefined value is 1 second) expires, the filter layer 22a records the success of binding update to this correspondent node 42 in the binding update list (BUL), and then deletes the binding acknowledgement 46 without passing to the upper internet layer 20a. Thus the steps of sending and receiving binding acknowledgement 46 do not involve the internet layer 20a of the mobile node 36 or the internet layer 20b of the correspondent node 42. In one embodiment, the BUL is maintained by the mobile node 36 only.

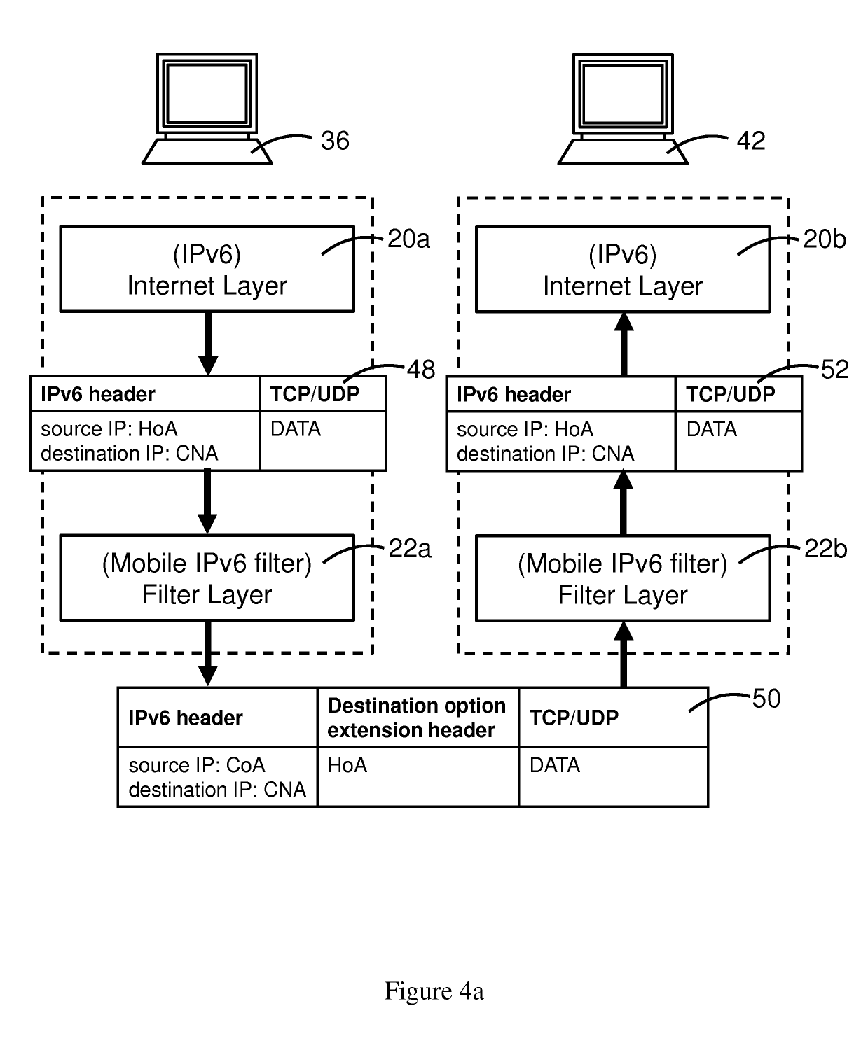

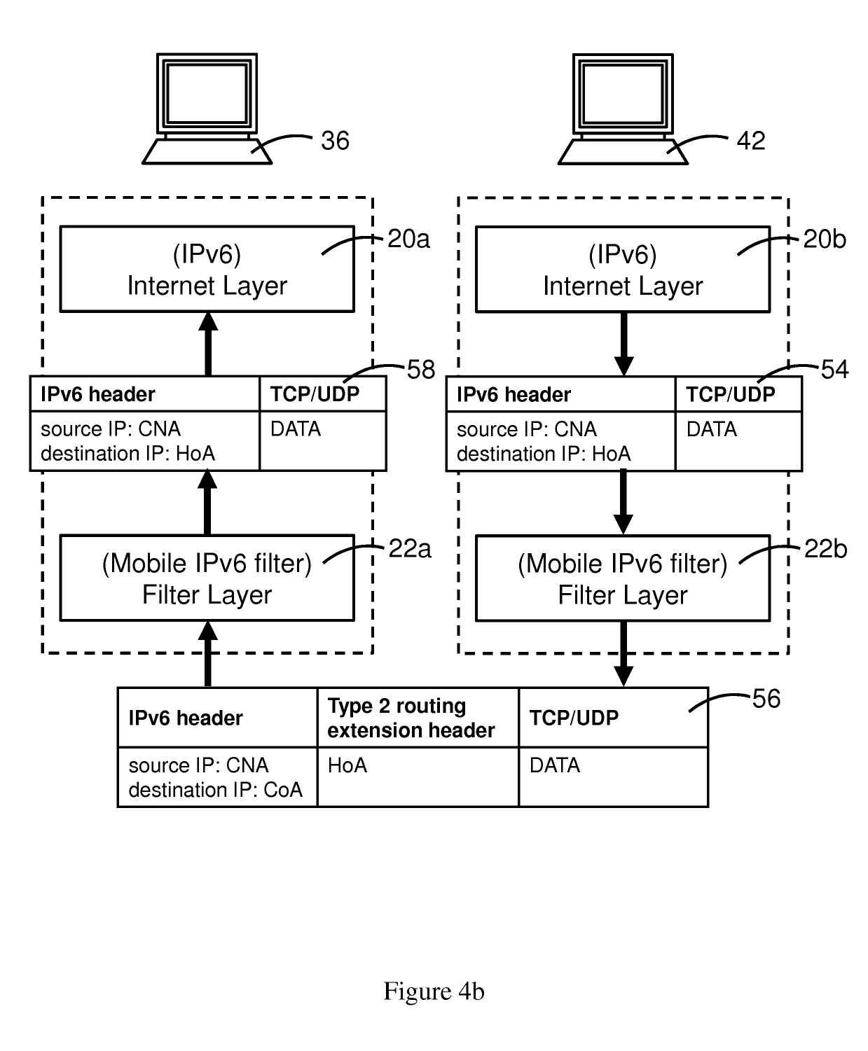

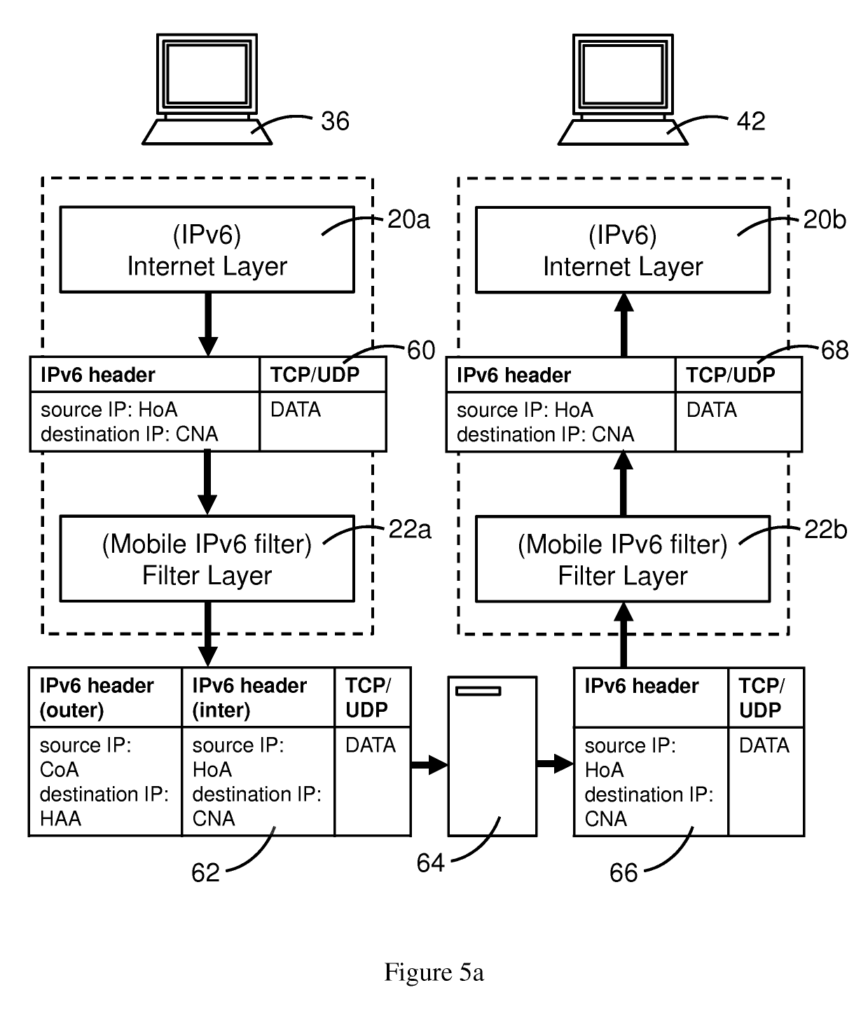

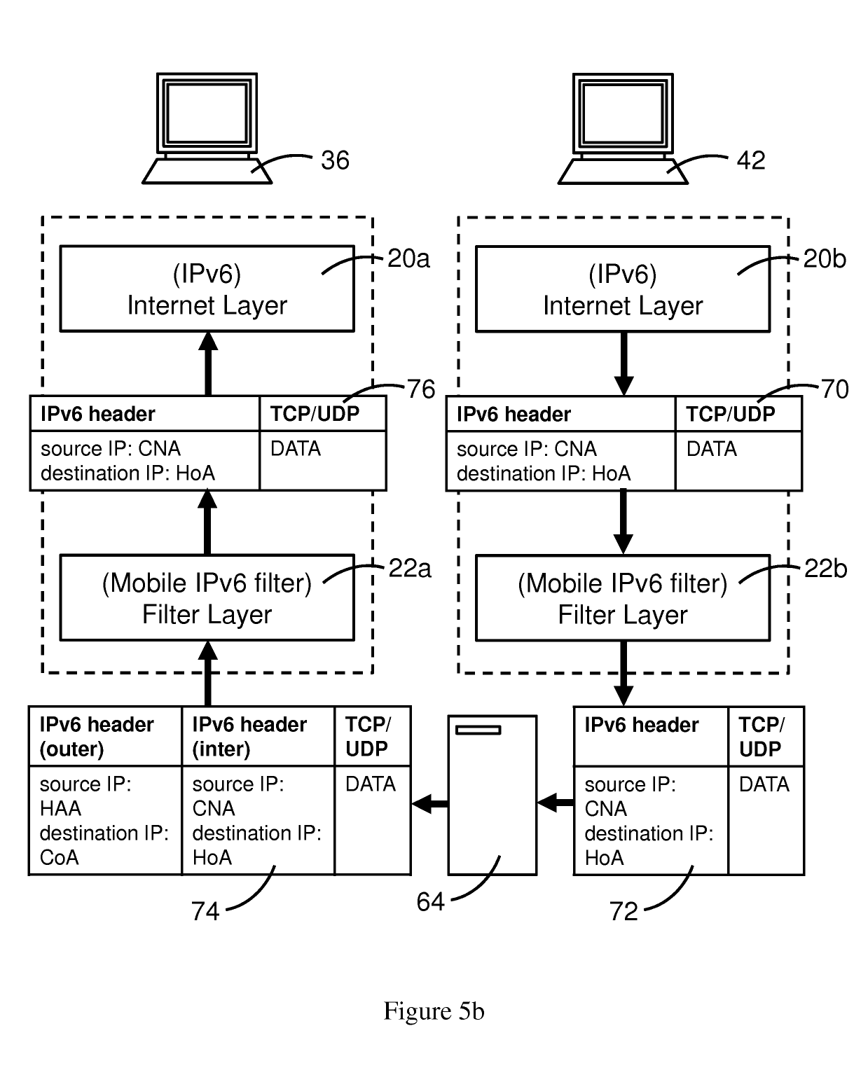

After complete the steps of updating the movement of the mobile node 36, the packets flowing to and from the internet layers 20a/20b need to be modified by the filter layer 22a/22b before delivering them between the mobile node 36 and the correspondent node 42. This guarantees the addresses used in the packets remain consistent before and after the movement of the mobile node 36, and thus the survivability of the ongoing connections can be maintained. The details of the aforesaid steps are illustrated and explained in FIG. 4 and FIG. 5.

Referring to FIG. 4a, if the binding is recorded both in the BUL of the mobile node 36 and the BC of the correspondent node 42, the packets are delivered between the mobile node 36 and the correspondent node 42 using extension headers. In an embodiment, when the mobile node 36 sends a packet to a corresponding node 42, the sending packet 48 comprises an IPv6 header and a TCP/UDP segment. The IPv6 header defines the source IP and the destination IP. In one specific embodiment, the source IP is the HoA and the destination IP is the CNA. When the sending packet 48 is passed to the filter layer 22a of the mobile node 36, an extension header is added to the sending packet 48 so as to generate a modified sending packet 50. In one embodiment, the extension header added is destination option extension header (DOH). The extension header comprises the HoA. Furthermore, the IP addresses of the IPv6 header of the modified sending packet 50 are also changed. In one embodiment, the source IP address is changed from HoA to CoA. In another embodiment, when the correspondent node 42 receives the modified sending packet 50, the filter layer 22b of the correspondent node 42 removes the DOH before passing the receiving packet 52 to the internet layer 20b. In a further embodiment, the source IP address of the receiving packet 52 is also changed from CoA back to HoA.

Referring to FIG. 4b, in an embodiment, when a corresponding node 42 sends a packet to the mobile node 36, the sending packet 54 comprises an IPv6 header and a TCP/UDP segment. The IPv6 header defines the source IP and the destination IP. In one specific embodiment, the source IP is the CNA and the destination IP is the HoA. When the sending packet 54 is passed to the filter layer 22b of the correspondent node 42, an extension header is added to the sending packet 54 so as to generate another modified sending packet 56. In one embodiment, the extension header added is type 2 routing extension header (RH2). The type 2 routing extension header comprises the HoA. Furthermore, the IP addresses of the IPv6 header of the modified sending packet 56 are also changed. In one embodiment, the destination IP address is changed from HoA to CoA. In another embodiment, when the mobile node 36 receives the modified sending packet 56, the filter layer 22a of the mobile node 36 removes the RH2 before passing the receiving packet 58 to the internet layer 20a. In a further embodiment, the destination IP address of the receiving packet 58 is also changed from CoA back to HoA.

Referring to FIG. 5a, if the binding is not presented in either the BUL of the mobile node 36 or the BC of the correspondent node 42, the packets is delivered between the mobile node 36 and the correspondent node 42 using tunneling via the home agent 64. In an embodiment, when the mobile node 36 sends a packet to a corresponding node 42, the sending packet 60 comprises an IPv6 header and a TCP/UDP segment. The IPv6 header defines the source IP and the destination IP. In one specific embodiment, the source IP is the HoA and the destination IP is the CNA. Then an outer IPv6 header is added to the sending packet 60 so as to generate a modified sending packet 62 by the filter layer 22a. In one embodiment, the outer IPv6 header defines the source IP and the destination IP. In one specific embodiment, the source IP is the CoA and the destination IP is the HAA. The modified sending packet 62 is then tunneled from the mobile node 36 to the correspondent node via the home agent 64. In one embodiment, when the home agent 64 receives the modified sending packet 62 tunneled from the mobile node 36, the home agent 64 removes the outer IPv6 header and continues forward the further modified sending packet 66 to the correspondent node 42. In another embodiment, when the correspondent node 42 receives the further modified sending packet 66, the filter layer 22b of the correspondent node 42 does not modify the further modified sending package 66 and passes the receiving packet 68 directly to the internet layer 20b.

Referring to FIG. 5b, when a corresponding node 42 sends a packet to the mobile node 36, the sending packet 70 comprises an IPv6 header and a TCP/UDP segment. The IPv6 header defines the source IP and the destination IP. In one specific embodiment, the source IP is the CNA and the destination IP is the HoA. The filter layer 22b of the correspondent node 42 does not modify the sending packet 70 and passes the un-modified sending packet 72 to the lower network access layer. When the un-modified sending packet 72 arrives to the home subnet of the mobile node 36, the home agent 64 intercepts the un-modified sending packet 72 on behalf of the mobile node 36 if the binding is presented in the BC of the home agent 64. In one embodiment, an outer IPv6 header is added to the sending packet so as to generate a modified sending packet 74. In a further embodiment, the outer IPv6 header defines a new source IP and a new destination IP. In one specific embodiment, the new source IP is the HAA and the new destination IP is the CoA. The modified sending packet 74 is then tunneled from the home agent 64 to the mobile node 36. In one embodiment, when the mobile node 36 receives the tunneled sending packet 74, the filter layer 22a of the mobile node 36 removes the outer IPv6 header before passes the receiving packet 76 to the upper internet layer 20a.

It is understood that the present invention can be realized in hardware, software, or a combination of hardware and software. Any kind of computer/server system(s)—or other apparatus adapted for carrying out the methods described herein—is suited. A typical combination of hardware and software could be a general purpose computer system with a computer program that, when loaded and executed, controls a computing device such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The computing device generally comprises central processing unit (CPU), memory, bus, input/output (I/O) interfaces, external devices/resources and database. CPU may comprise a single processing unit, or be distributed across one or more processing units in one or more locations. Memory may comprise any known type of data storage and/or transmission media, including magnetic media, optical media, random access memory (RAM), read-only memory (ROM), a data cache, a data object, etc. Moreover, similar to CPU, memory may reside at a single physical location, comprising one or more types of data storage, or be distributed across a plurality of physical systems in various forms. [Inventors: The two paragraphs above were added in order to fulfill the US patent requirements.]

The exemplary embodiments of the present invention are thus fully described. Although the description referred to particular embodiments, it will be clear to one skilled in the art that the present invention may be practiced with variation of these specific details. Hence this invention should not be construed as limited to the embodiments set forth herein.

What is claimed is:

1. A method of providing mobility support to Internet Protocol version 6 (IPv6) comprising the steps of:
a) providing a filter layer in the TCP/IP stack, wherein said filter layer is below the internet layer and above the network access layer; and
b) modifying packets by using said filter layer;
wherein said internet layer is encoded with a non-mobility-capable IPv6 module and said filter layer is encoded with a filtering protocol module supporting the Mobile Internet Protocol version 6 (MIPv6) mechanisms.

2. The method of claim 1, wherein said step of modifying said packets further comprises the steps of:
a) detecting movement of a mobile node by said filter layer; and
b) updating said movement of said mobile node to home agent and correspondent nodes by said filter layer.

3. The method of claim 2, wherein said step of detecting said movement of said mobile node further comprises a step of hiding said movement of said mobile node from said non-mobility-capable IPv6 module of said internet layer by replacing the prefix in the receiving packets before passing said receiving packets to said internet layer; wherein said prefix indicates the current subnet said mobile node belongs to.

4. The method of claim 2, wherein said step of updating said movement of said mobile node to said home agent and said correspondent nodes further comprises the steps of:
a) sending a binding update from said filter layer of said mobile node to said home agent and said correspondent nodes; wherein said binding update comprises a first address at home subnet of said mobile node and a second address at current foreign subnet of said mobile node; and
b) replying a binding acknowledgement from said filter layer of one of said correspondent nodes to said mobile node.

5. The method of claim 1, wherein said packets comprises sending packets and receiving packets; wherein said step of modifying said packets by said filter layer further comprises the steps of:
a) adding extension headers and replacing IP addresses to said sending packets;
b) deleting extension headers and restoring IP addresses from said receiving packets;
c) tunneling said sending packets to correspondent node via home agent; and
d) restoring receiving tunneled packets.
